(19) United States
(12) Patent Application Publication
(10) Pub. No.: US 2011/0055295 A1
(43) Pub. Date: Mar. 3, 2011

(54) SYSTEMS AND METHODS FOR CONTEXT AWARE FILE SEARCHING

(75) Inventors: Manish Bhide, New Delhi (IN); Ajay Gupta, New Delhi (IN); Mukesh K. Mohania, New Delhi (IN); Girish Venkatachaliah, Bangalore (IN)

(73) Assignee: International Business Machines Corporation, Armonk, NY (US)

(21) Appl. No.: 12/551,630

(22) Filed: Sep. 1, 2009

(51) Int. Cl. G06F 17/30

(52) U.S. Cl. 707/822; 707/E17.014

(57) ABSTRACT

Embodiments of the invention broadly contemplate systems, apparatuses and methods providing simplified file searching using peripheral external information derived from one or more external sources. The peripheral external information corresponds to the context in which the user received and/or saved the file.

### BACKGROUND

Many times computer users try to search for a saved file but cannot remember certain things about where the file is located. This makes retrieving the file from the electronic device (for example a computer) difficult. The user may, however, remember something about the context relating to the file save. For example, a user may remember that a person “X” sent the file via email but may not know the file's name and/or location. As another example, a user may remember that the file was downloaded from a particular Internet web site or was received using a certain chat program. Thus, a user might remember peripheral external information about the context in which a file was received and/or saved.

### BRIEF SUMMARY

Conventional systems, methods and apparatuses do not facilitate the use of peripheral external information regarding the context in which a file was received and/or saved for searching for the file. Accordingly, embodiments of the invention broadly contemplate systems, apparatuses and methods providing simplified file (for example a document) searching using peripheral external information derived from one or more external sources. The peripheral external information corresponds to the context in which the user received and/or saved the file.

In summary, one aspect of the invention provides an apparatus comprising: one or more processors; and a computer readable storage medium having computer readable code embodied therewith and executable by the one or more processors, the computer readable program code comprising: computer readable program code configured to extract peripheral external information from one or more external sources in response to a predetermined action, the predetermined action comprising an action associated with saving a file; computer readable program code configured to associate the peripheral external information with the file; and computer readable program code configured to store the peripheral external information in a searchable repository.

Another aspect of the invention provides a method comprising: utilizing one or more processors of a machine to execute computer readable program code configured to extract peripheral external information from one or more external sources in response to a predetermined action, the predetermined action comprising an action associated with saving a file; and utilizing the one or more processors of the machine to execute computer readable program code configured to associate the peripheral external information with the file; and utilizing the one or more processors of the machine to execute computer readable program code configured to store the peripheral external information in a searchable repository.

A further aspect of the invention provides a computer program product comprising: a computer readable storage medium having computer readable program code embodied therewith, the computer readable program code comprising: computer readable program code configured to extract peripheral external information from one or more external sources in response to a predetermined action, the predetermined action comprising an action associated with saving a file; computer readable program code configured to associate the peripheral external information with the file; and computer readable program code configured to store the peripheral external information in a searchable repository.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 illustrates a computer system according to an embodiment of the invention.

FIG. 2 illustrates a context aware search flow according to an embodiment of the invention.

FIG. 3 illustrates a search process flow according to an embodiment of the invention.

FIG. 4 illustrates a method of contextual searching using an email client according to an embodiment of the invention.

FIG. 5 illustrates a method of contextual searching using a chat client according to an embodiment of the invention.

### DETAILED DESCRIPTION

It will be readily understood that the components of the embodiments of the invention, as generally described and illustrated in the figures herein, may be arranged and designed in a wide variety of different configurations in addition to the described presently preferred embodiments. Thus, the following more detailed description of the embodiments of the invention, as represented in the figures, is not intended to limit the scope of the embodiments of the invention, as claimed, but is merely representative of selected presently preferred embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments of the invention. One skilled in the relevant art will recognize, however, that the various embodiments of the invention can be practiced without one or more of the specific details, or with other methods, components, materials, etc. In other instances, well-known structures, materials, or operations are not shown or described in detail to avoid obscuring aspects of the invention.

The illustrated embodiments of the invention will be best understood by reference to the drawings. The following description is intended only by way of example and simply illustrates certain selected presently preferred embodiments of the invention as claimed herein.

The flowchart and block diagrams in the figures illustrate the architecture, functionality, and operation of possible implementations of systems, methods and computer program products according to various embodiments of the invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The inventors have recognized that many times a user attempts to search for a file with limited information. The user may not recall the file name and/or location in which the file is stored. However, the user may recall certain peripheral external information regarding the context in which the file came to the user and/or was stored by the user.

Unfortunately, the inventors have recognized that the mail message or chat session application from which a file is received and downloaded is generally deleted/closed shortly after use. Thus, even if the user remembers information about the email message sender, or the particular chat in which the file came to the user, this information is essentially useless. Moreover, the inventors have recognized that folders storing such files are frequently disorganized, with multiple folders storing similar files with nondescript names. Hence, the inventors have recognized that it is often difficult for a user to locate a file if the user does not remember the file name and/or location in which the file has been stored.

Still further, the inventors have recognized that conventional arrangements do not gather, save/store and utilize peripheral external information from external sources regarding the context in which the file was received and/or saved, such that the user cannot leverage this additional information to locate the file of interest. For example, the user may not even recall the particular sender that sent a file; however, the user may recall that the file came from someone working on a particular project or from someone working for a particular department within a company, and the like. Such information may be available from one or more external sources.

Accordingly, the inventors have recognized a need for permitting searching based on peripheral external information extracted from one or more external sources related to the context in which the file was received and/or saved.

Embodiments of the invention enable an electronic device (or “system”) to search for a file based on peripheral external information associated with the file. When a file (for example an email attachment consisting of a word processing document) is downloaded, embodiments of the invention automatically gather additional peripheral external information from one or more external sources and store this peripheral external information, associated with the file.

According to embodiments of the invention, the peripheral external information may comprise meta-data associated with the file of interest derived from a wide variety of sources. For example, the peripheral external information may include but is not limited to information associated with the sender of the file, information associated with the application program in which the file was received (e.g. email application), information associated with the subject line of the email message, information associated with the carbon copy line (“CC” line), information associated with the text of the email, information associated with the sender's name, information associated with the sender's company name, information associated with the sender's location, information associated with the time of receipt and/or download, and the like.

Various embodiments of the invention enable collection of information useful for searching from a variety of sources, including but not limited to one or more external sources such as corporate directories and/or social networking web sites. For example, an email message from which a file is received and saved could be linked with other data sources such as a social networking site (profile) associated with the sender to extract peripheral external information. In this regard, peripheral external information, for example an email sender's company name, hometown, designation etc., as derived from a social networking site, can be automatically extracted and associated with an attachment contained in an email communication sent by this particular sender. Thus, embodiments of the invention enable searching for the file based on this peripheral external information gathered from external sources.

As another example, a mail client could be linked with corporate directory information to extract extra peripheral external information about the sender, for example the department within the company in which the sender currently works, the project on which the sender works and so on. The peripheral external information can be added to a searchable repository, for example an inverted index, as a set of keywords. The inverted index, by way of example, maps the set of keywords found in context to the file in a way that facilitates searching for the file based on the key words. Accordingly, a user can search using these keywords and locate the file, even though the keywords may not have been originally contained in the file or associated with it (for example present in the email/chat) in some explicit way. In other words, embodiments of the invention facilitate automatic gathering of additional peripheral external information from external sources that should prove useful to users attempting to locate a file.

According to various embodiments of the invention, once peripheral external information is stored in an appropriate repository, for example an inverted index, it can be used by a search algorithm (for example term frequency-inverse document frequency (TF-IDF)) that makes use of the information stored in the repository to find a file based on a keyword search. Thus, embodiments of the invention automatically extract peripheral external information relating to the file from one or more external sources, for example upon opening or saving the file, in order to facilitate later searching based on peripheral external information not conventionally available but often remembered by the user. As such, embodiments of the invention enable searching related to the associated context, which is much more likely to enable the user to remember and locate the file using a search tool.

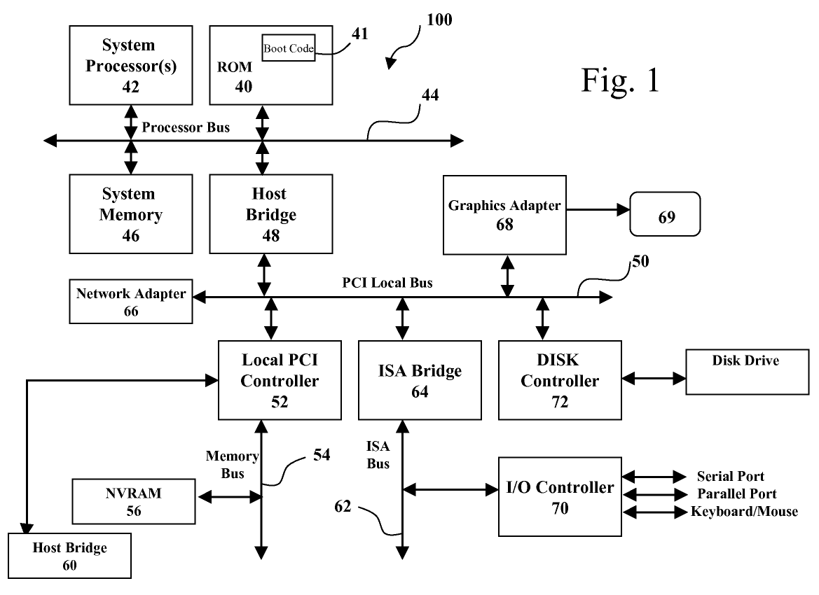

Referring now to FIG. 1, there is depicted a block diagram of an illustrative embodiment of a computer system 100. The illustrative embodiment depicted in FIG. 1 may be an electronic device such as a desktop or workstation computer. As is apparent from the description, however, the embodiments of the invention may be implemented in any appropriately configured device, as described herein.

As shown in FIG. 1, computer system 100 includes at least one system processor 42, which is coupled to a Read-Only Memory (ROM) 40 and a system memory 46 by a processor bus 44. System processor 42, which may comprise one of the AMD line of processors produced by AMD Corporation or a processor produced by INTEL Corporation, is a general-purpose processor that executes boot code 41 stored within ROM 40 at power-on and thereafter processes data under the control of an operating system and application software stored in system memory 46. System processor 42 is coupled via processor bus 44 and host bridge 48 to Peripheral Component Interconnect (PCI) local bus 50.

PCI local bus 50 supports the attachment of a number of devices, including adapters and bridges. Among these devices is network adapter 66, which interfaces computer system 100 to LAN, and graphics adapter 68, which interfaces computer system 100 to display 69. Communication on PCI local bus 50 is governed by local PCI controller 52, which is in turn coupled to non-volatile random access memory (NVRAM) 56 via memory bus 54. Local PCI controller 52 can be coupled to additional buses and devices via a second host bridge 60.

Computer system 100 further includes Industry Standard Architecture (ISA) bus 62, which is coupled to PCI local bus 50 by ISA bridge 64. Coupled to ISA bus 62 is an input/output (I/O) controller 70, which controls communication between computer system 100 and attached peripheral devices such as a as a keyboard, mouse, serial and parallel ports, etc. A disk controller 72 connects a disk drive with PCI local bus 50. The USB Bus and USB Controller (not shown) are part of the Local PCI controller (52).

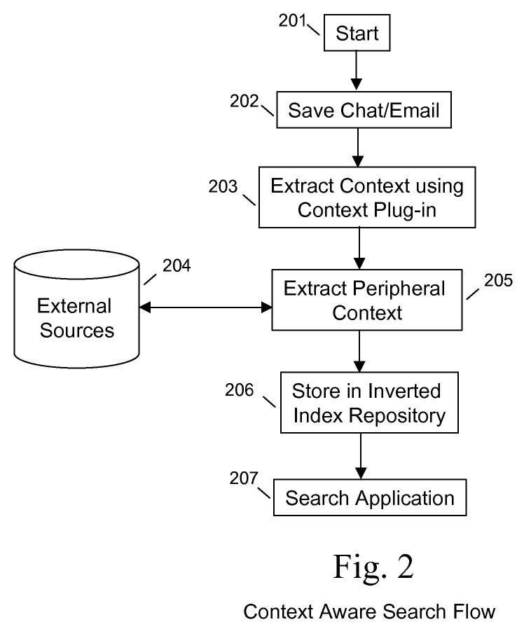

Referring now to FIG. 2 a context aware search flow according to an embodiment of the invention is illustrated. The context aware search flow can be executed by an application program, implemented for example as a program of instructions that is executed by a processor of a computer system, such as computer system 100. The process starts at 201 when, for example, an application program launches and/or executes in response to a predetermined action associated with accessing and/or saving a file, for example opening of an email attachment or executing a download of a file from a chat program, and/or saving an email attachment or saving a file downloaded to a chat program. It will be appreciated by those having ordinary skill in the art that the file can be saved to a variety of locations, however the non-limiting description presented herein focuses on the use-case where a user saves the file to a local client (for example, a user's laptop, desktop, or other computing device).

At 202, the application program saves the file in response to the predetermined action. At 203, the application (for example a plug-in) extracts context information related to internal sources, for example the email application program itself, for use in extracting peripheral external (peripheral context) information from one or more external sources. The internal sources may include but are not limited to the subject line of the email message.

At 205, the application program extracts peripheral context from one or more external sources 204. As discussed herein, the one or more external sources can include but are not limited to network connected relevant sources of information such as corporate directories, social networking sites, and/or remote web sites associated in some relevant way with the file. These external sources 204 comprise peripheral external information useful in later searching for the file. For example, the external sources 204 may include such peripheral external information as the name of the creator or sender of the file and information gather from social networking sites such as a LINKED-IN profile of the sender of the file. Such profile information may include for example the name, designation (current, past), education, summary of past experience, publications, the owner of a social networking site, the name of a company or host of the networking site and the like. The peripheral external information extracted can be customized, but preferably includes noticeable information that a user is likely to associate and remember with the file download and save action.

Once peripheral external information is extracted at 205, the peripheral external information is stored in an inverted index repository at 206 as one or more keywords associated with the file. The peripheral external information is stored in the inverted index repository in a manner, such as the set of keywords, that facilitates searching the inverted index repository 207 by the user in order to locate the file.

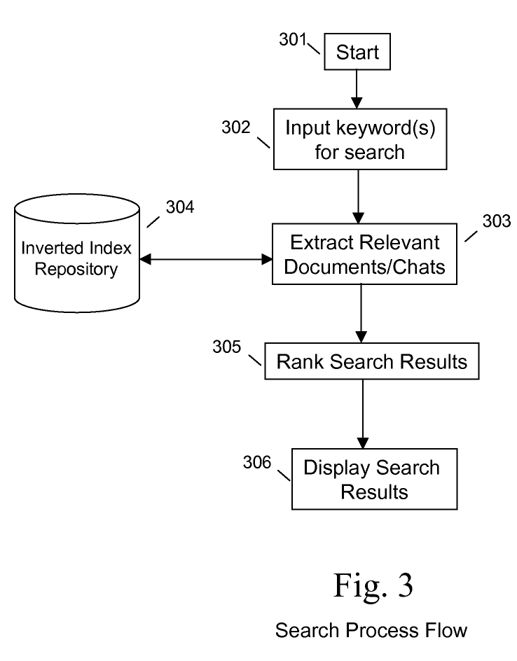

Referring now to FIG. 3, a search process flow according to an embodiment of the invention is illustrated. Again, the search process flow can be executed by an application program, implemented for example as a program of instructions that is executed by a processor of a computer system, such as computer system 100. At 301, the process starts in response to a predetermined action, for example a user initiating a search application via a user interface. At 302, the user can input one or more keywords for searching based on the extracted, stored peripheral external information. At 303, the application program can extract relevant files saved from the inverted index repository 304. The relevant files can include but are not limited to email attachments, documents downloaded from web sites, chats and the like. At 305, the search tool can rank the search results in a relevant way, for example according to a TF-IDF weighting algorithm or the like. Ranked search results can then be displayed to the user at 306.

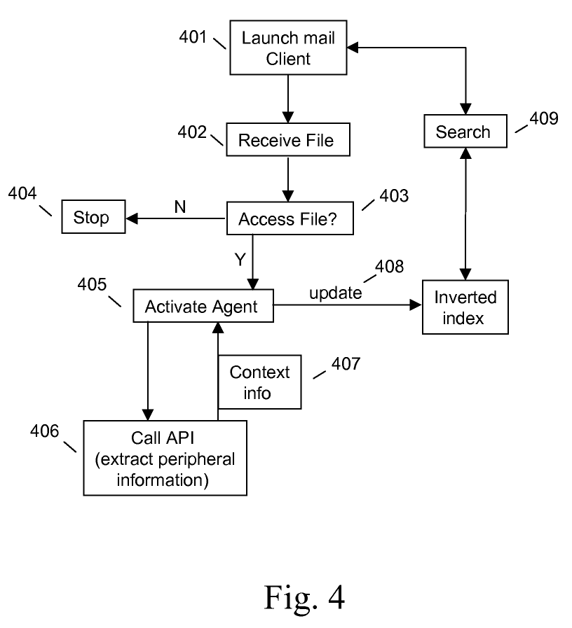

Referring now to FIG. 4, a method of contextual searching using an email (mail) client according to an embodiment of the invention is illustrated. A user launches a mail client at 401. When a file is received (for example a word processing document attached to the email) at 402, the user may access (for example, download and save) the file at 403. If the user does not access the file, the process may stop at 404. However, if the file is accessed, an agent (for example, of an application program as described herein) is activated at 405. The activated agent can call a fixed API to extract peripheral external information (meta-data) from one or more sources associated with the file (for example using the internal contextual information) at 406. Again, this peripheral external information (“context info”) can be gathered from internal and/or external sources. Preferably, the peripheral external information includes information gathered from one or more external sources such as a corporate directory and/or social networking sites.

At 407 the peripheral external information is related to the file accessed at 403 by the activated agent. This relation can be, as a non-limiting example, facilitated by linking of the corporate directory information about the sender to the accessed file. For example, LOTUS NOTES mail software from IBM can be linked with a company's corporate directory to get information such as identification that the sender of the email is from a certain department within the company organization. As another non-limiting example, a GMAIL user could be linked with ORKUT profile to obtain extra profile information about the sender of the email. At 408, the context information is added to an inverted index as a set of keywords can be used when a user launches a search algorithm at 409 within the mail client for later retrieval of the file.

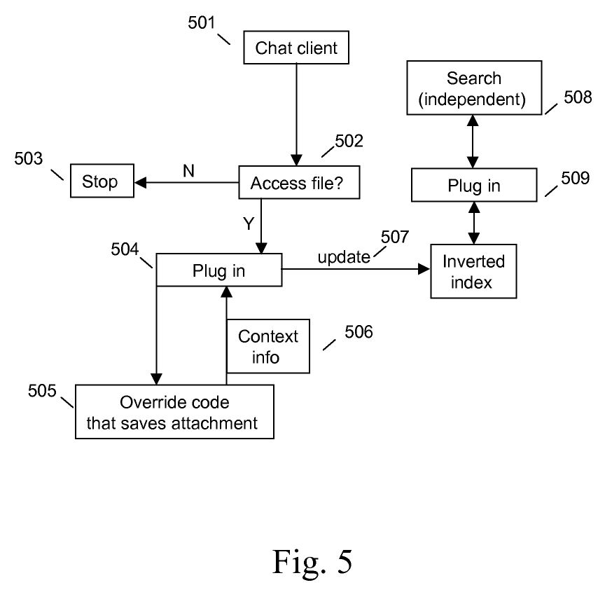

Referring now to FIG. 5, a method of contextual searching using a chat client according to an embodiment of the invention is illustrated. At 501, a user launches a chat program, for example AOL INSTANT MESSENGER. The user can access a file (for example, opening a linked PDF document (file) by clicking on a link and saving the document). At 502, if the user decides not to save the file, the process may stop at 503. However, at 502, if the user decides to save the file, a plug-in is preferably launched at 504. At 505, the plug-in can override the code normally utilized to save the file to the local client (for example a personal computer and the like). The plug-in can gather context information regarding the file save action and use it to extract peripheral external information at 506. Again, this peripheral external information may be, for example, information gathered from a variety of sources and preferably includes a corporate directory or a social networking site. At 507, the plug-in updates an inverted index with the context information as a set of keywords associated with the file, useful to a search algorithm launched at 508 and used for retrieval at 509 from the inverted index.

In brief recapitulation, embodiments of the invention provide for gathering and storing peripheral external information regarding file downloading and saving useful for more easily and flexibly locating the file. Embodiments of the invention automatically extract peripheral external information from one or more external sources, associate it with a saved file, and save it for later searching. Accordingly, embodiments of the invention facilitate contextual searching based on the peripheral external information, enabling users to leverage new and useful information regarding the file to search for and locate it.

As will be appreciated by one skilled in the art, aspects of the invention may be embodied as a system, method or computer program product. Accordingly, aspects of the invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the invention may be written in any combination of one or more programming languages, including an object oriented programming language such as Java, Smalltalk, C++ or the like and conventional procedural programming languages, such as the “C” programming language or similar programming languages. The program code may execute entirely on the user's computer (device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure for various embodiments with various modifications as are suited to the particular use contemplated.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

1. An apparatus comprising:
one or more processors; and
a computer readable storage medium having computer readable code embodied therewith and executable by the one or more processors, the computer readable program code comprising:
computer readable program code configured to extract peripheral external information from one or more external sources in response to a predetermined action, the predetermined action comprising an action associated with saving a file;
computer readable program code configured to associate the peripheral external information with the file; and
computer readable program code configured to store the peripheral external information in a searchable repository.

2. The apparatus according to claim 1, wherein the computer readable program code further comprises computer readable program code configured to enable searching the searchable repository.

3. The apparatus according to claim 2, wherein the computer readable program code configured to associate the peripheral external information with the file is further configured to compile one or more keywords from the peripheral external information.

4. The apparatus according to claim 3, wherein the computer readable program code configured to store the peripheral external information in a searchable repository is further configured to store the one or more keywords in the searchable repository in a manner associated with the file.

5. The apparatus according to claim 1, wherein the file comprises one or more of a file received as an email attachment, a file accessed via a remote web site, and a file received in a chat session.

6. The apparatus according to claim 1, wherein the computer readable program code configured to extract peripheral external information from one or more external sources in response to a predetermined action is further configured to extract the peripheral external information from a social networking web site.

7. The apparatus according to claim 1, wherein the computer readable program code configured to extract peripheral external information from one or more external sources in response to a predetermined action is further configured to extract the peripheral external information from a corporate directory linked to an email client used to receive an email message containing the file.

8. The apparatus according to claim 1, wherein the computer readable program code configured to extract peripheral external information from one or more external sources in response to a predetermined action is further configured to extract the peripheral external information from a remote web site linked to an email client used to receive an email message containing the file.

9. The apparatus according to claim 1, wherein the peripheral external information comprises one or more of a user name, a profile name, a company name, a department name, and social networking profile information associated with the file.

10. A method comprising:
utilizing one or more processors of a machine to execute computer readable program code configured to extract peripheral external information from one or more external sources in response to a predetermined action, the predetermined action comprising an action associated with saving a file; and
utilizing the one or more processors of the machine to execute computer readable program code configured to associate the peripheral external information with the file; and
utilizing the one or more processors of the machine to execute computer readable program code configured to store the peripheral external information in a searchable repository.

11. The method according to claim 10, further comprising utilizing the one or more processors of the machine to execute computer readable program code configured to enable searching the searchable repository.

12. The method according to claim 11, wherein the computer readable program code configured to associate the peripheral external information with the file is further configured to compile one or more keywords from the peripheral external information.

13. The method according to claim 12, wherein the computer readable program code configured to store the peripheral external information in a searchable repository is further configured to store the one or more keywords in the searchable repository in a manner associated with the file.

14. The method according to claim 10, wherein the file comprises one or more of a file received as an email attachment, a file accessed via a remote web site, and a file received in a chat session.

15. The method according to claim 10, wherein the computer readable program code configured to extract peripheral external information from one or more external sources in response to a predetermined action is further configured to extract the peripheral external information from a social networking web site.

16. The method according to claim 10, wherein the computer readable program code configured to extract peripheral external information from one or more external sources in response to a predetermined action is further configured to extract the peripheral external information from a corporate directory linked to an email client used to receive an email message containing the file.

17. The method according to claim 10, wherein the computer readable program code configured to extract peripheral external information from one or more external sources in response to a predetermined action is further configured to extract the peripheral external information from a remote web site linked to an email client used to receive an email message containing the file.

18. The method according to claim 10, wherein the peripheral external information comprises one or more of a user name, a profile name, a company name, a department name, and social networking profile information associated with the file.

19. The method according to claim 10, wherein the searchable repository comprises an inverted index.

20. A computer program product comprising:
a computer readable storage medium having computer readable program code embodied therewith, the computer readable program code comprising:
computer readable program code configured to extract peripheral external information from one or more external sources in response to a predetermined action, the predetermined action comprising an action associated with saving a file;
computer readable program code configured to associate the peripheral external information with the file; and
computer readable program code configured to store the peripheral external information in a searchable repository.
